(19) United States
(12) Patent Application Publication
(10) Pub. No.: US 2010/0273007 A1
(43) Pub. Date: Oct. 28, 2010

(54) DEHALOGENATION

(75) Inventor: Elena E. SHEINA, Pittsburgh, PA (US)

Correspondence Address: FOLEY AND LARDNER LLP;SUITE 500, 3000 K STREET NW, WASHINGTON, DC, 20007, US

(73) Assignee: Plextronics, Inc.

(21) Appl. No.: 12/757,814

(22) Filed: Apr. 9, 2010

Related U.S. Application Data
(60) Provisional application No. 61/168,470, filed on Apr. 10, 2009.

(51) Int. Cl. B32B 27/06; C08G 75/06; C08L 81/02

(52) U.S. Cl. 428/419; 528/380; 528/379; 524/609

(57) ABSTRACT

Post-polymerization treatment including dehalogenation of polymeric materials including debromination of polythiophenes. The polymers can be used in organic electronic devices like OLEDs and OPVs. Improved lifetime and stability can result.

### RELATED APPLICATIONS

This application claims priority to U.S. provisional application Ser. No. 61/168,470 filed Apr. 10, 2009, the complete disclosure of which is hereby incorporated by reference in its entirety.

### BACKGROUND

A need exists to improve the performance of organic electronic devices such as, for example, OLEDs, OPVs, and OFETs. In particular, issues such as device efficiency, mobility, stability, and lifetime can be important for further commercialization. To achieve these improvements in commercial devices, better materials and processes are needed.

### SUMMARY

Embodiments described herein include methods of making, compositions, devices, methods of using, inks, oligomers, polymers, and the like.

One embodiment provides, for example, a composition comprising: at least one polythiophene, wherein the polythiophene has been prepared by steps which comprise a dehalogenation step. In one embodiment, the dehalogenation step is carried out with a reagent which is compatible with the side group of the polythiophene. In particular, the dehalogenation reagent can be compatible with optionally substituted alkoxy and alkyleneoxy side groups.

Another embodiment provides a composition comprising: at least one polythiophene, wherein the polythiophene has been prepared by steps which comprise a dehalogenation step, and at least one solvent for the polymer.

Another embodiment provides a method comprising: dehalogenating at least one polythiophene.

Another embodiment provides a device comprising: a substrate, a plurality of layers disposed on the substrate, wherein at least one of the layers comprises at least one polythiophene which has been prepared by a dehalogenation step.

Another embodiment provides a device comprising: at least one organic photovoltaic device comprising at least one active layer, wherein the active layer comprises at least one polymer which has been prepared by steps comprising a dehalogenation step.

At least one advantage of at least one embodiment is improved performance in an organic electronic devices such as an OPV, an OLED, or an OFET, including, for example, improved efficiency, lifetime, and/or mobility, as well as combinations of improved properties.

### DETAILED DESCRIPTION

### Introduction

All references cited herein are incorporated by reference in their entireties.

Copending application “Doped Conjugated Polymers, Devices, and Methods of Making Devices” filed Apr. 10, 2009 (Ser. No. 12/422,159; publication no. 2009/0256117) to Brown et al. (assignee: Plextronics, Inc.), as well as priority applications 61/044,380 filed Apr. 11, 2008 and 61/119,239 filed Dec. 2, 2008, describe polymers and processes of making polymers, and use of the polymers in organic electronic devices. See also US provisional 61,287,977 filed Dec. 18, 2009, including its description of copolymers.

### Polymer, Conjugated Polymer, Polythiophene

A polymer such as, for example, a conjugated polymer such as, for example, a polythiophene can be subjected to a dehalogenation step.

In particular, a composition can comprise at least one conjugated polymer. Conjugated polymers are known in the art including their use in organic electronic devices. See, for example, Friend, “Polymer LEDs,” Physics World, November 1992, 5, 11, 42-46; see, for example, Kraft et al., “Electroluminescent Conjugated Polymers-Seeing Polymers in a New Light,” Angew. Chem. Int. Ed. 1998, 37, 402-428. In addition, electrically conductive or conjugated polymers are described in The Encyclopedia of Polymer Science and Engineering, Wiley, 1990, pages 298-300, including polyacetylene, poly(p-phenylene), poly(p-phenylene sulfide), polypyrrole, and polythiophene, including families of these polymers and derivatives in these polymer systems, which is hereby incorporated by reference in its entirety. This reference also describes blending and copolymerization of polymers, including block copolymer formation.

The conjugated polymer can be any conjugated polymer, including polythiophenes, and can be homopolymers, copolymers, or block copolymers. Synthetic methods, doping, and polymer characterization, including regioregular polythiophenes with side groups, is provided in, for example, U.S. Pat. Nos. 6,602,974 to McCullough et al. and 6,166,172 to McCullough et al., which are hereby incorporated by reference in their entirety. Additional description can be found in the article, “The Chemistry of Conducting Polythiophenes,” by Richard D. McCullough, Adv. Mater. 1998, 10, No. 2, pages 93-116, and references cited therein, which is hereby incorporated by reference in its entirety. Another reference which one skilled in the art can use is the Handbook of Conducting Polymers, 2^{nd} Ed. 1998, Chapter 9, by McCullough et al., “Regioregular, Head-to-Tail Coupled Poly(3-alkylthiophene) and its Derivatives,” pages 225-258, which is hereby incorporated by reference in its entirety. This reference also describes, in chapter 29, “Electroluminescence in Conjugated Polymers” at pages 823-846, which is hereby incorporated by reference in its entirety.

Polythiophenes are also described, for example, in Roncali, J., Chem. Rev. 1992, 92, 711; Schopf et al., Polythiophenes: Electrically Conductive Polymers, Springer: Berlin, 1997. See also for example U.S. Pat. Nos. 4,737,557 and 4,909,959.

Polymeric semiconductors are described in, for example, “Organic Transistor Semiconductors” by Katz et al., Accounts of Chemical Research, vol. 34, no. 5, 2001, page 359 including pages 365-367, which is hereby incorporated by reference in its entirety.

Conjugated polymers can be, for example, copolymers including block copolymers. Block copolymers are described in, for example, Block Copolymers, Overview and Critical Survey, by Noshay and McGrath, Academic Press, 1977. For example, this text describes A-B diblock copolymers (chapter 5), A-B-A triblock copolymers (chapter 6), and -(AB)ₙ-multiblock copolymers (chapter 7), which can form the basis of block copolymer types in the present invention.

Additional block copolymers including polythiophenes are described in, for example, Francois et al., Synth. Met. 1995, 69, 463-466, which is incorporated by reference in its entirety; Yang et al., Macromolecules 1993, 26, 1188-1190; Widawski et al., Nature (London), vol. 369, Jun. 2, 1994, 387-389; Jenekhe et al., Science, 279, Mar. 20, 1998, 1903-1907; Wang et al., J. Am. Chem. Soc. 2000, 122, 6855-6861; Li et al., Macromolecules 1999, 32, 3034-3044; Hempenius et al., J. Am. Chem. Soc. 1998, 120, 2798-2804.

Substituents which can be used to solubilize conducting polymers with side chains include alkoxy and alkyl including for example C1 to C25 groups, as well as heteroatom systems which include for example oxygen and nitrogen. In particular, substituents having at least three carbon atoms, or at least five carbon atoms can be used. Mixed substituents can be used. The substituents can be nonpolar, polar or functional organic substituents. The side group can be called a substituent R which can be for example alkyl, perhaloalkyl, vinyl, acetylenic, alkoxy, aryloxy, vinyloxy, thioalkyl, thioaryl, ketyl, thioketyl, and optionally can be substituted with atoms other than hydrogen.

Conjugated polymers can comprise heterocyclic monomer repeat units, and heterocyclic polymers are particularly preferred. A particularly preferred system is the polythiophene system and the 3,4-disubstituted polythiophene system. Polymers can be obtained from Plextronics, Inc., Pittsburgh, Pa. including, for example, polythiophene-based polymers such as, for example, PLEXCORE, and similar materials.

One important example of a conjugated polymer, and formulations and devices using the polymer, is a 3,4-disubstituted polythiophene. Preferably, the 3,4-disubstituted polythiophene may be a poly(3,4-dialkoxythiophene) or a poly(3,4-di-polyether)-thiophene. A polyether is a molecule with more than one ether group.

The 3,4-disubstituted polythiophene may have a symmetrical monomer repeating unit. Often times, the 3,4-disubstituted polythiophene comprises a 3,4-substituted thiophene as the repeating unit, with an oxygen atom directly attached to the 3- and 4-positions of the disubstituted thiophene and polymerized through the 2- and 5-positions. Substituents can be used to solubilize the 3,4-substituted thiophene with side chains that can include alkoxy and polyether, including for example, straight or branched carbon chains, for example, C1 to C25 groups, wherein one, two, three, four, five, or six of the carbon atoms in the chains may be replaced by heteroatoms, such as, oxygen and/or nitrogen.

The conjugated polymer may be prepared by polymerization of a monomer unit, such as 2,5-dibromo-3,4-bis(2-(2-butoxyethoxy)ethoxy)thiophene, or 2,5-dibromo-3,4-bis(2-(2-ethoxyethoxy)ethoxy)thiophene; 2,5-dibromo-3,4-bis(2-(2-methoxyethoxy)ethoxy)thiophene; 2,5-dibromo-3,4-bis(2-(2-butoxyethoxy)ethoxy)thiophene; 2,5-dibromo-3,4-bis(2-(2-butoxybutoxy)butoxy)thiophene; and 2,5-dibromo-3,4-bis(2-(2-methoxymethoxy)methoxy)thiophene.

Any known methods of polymerization may be used to obtain the 3,4-disubstituted polythiophene. Typically, the polymer itself can be obtained by GRIM polymerization of the 2,5-dibromo derivative of the dialkoxythiophene or dipolyetherthiophene using a Nickel catalyst.

GRIM polymerization of a symmetrical monomer is described in, for example, Campos et al., Photovoltaic Activity of a PolyProDOT Derivative in a Bulk Heterojunction Solar Cell, Solar Energy Materials & Solar Cells, August 2006.

The conjugated polymer can be a 3,4-disubstituted polythiophene, such as poly(3,4-bis(2-(2-butoxyethoxy)ethoxy)thiophene)-2,5-diyl, poly(3,4-bis(2-(2-ethoxyethoxy)ethoxy)thiophene)-2,5-diyl; poly(3,4-bis(2-(2-methoxyethoxy)ethoxy)thiophene)-2,5-diyl; poly(3,4-bis(2-(2-butoxyethoxy)ethoxy)thiophene)-2,5-diyl; poly(3,4-bis(2-(2-butoxybutoxy)butoxy)thiophene)-2,5-diyl; and poly(3,4-bis(2-(2-methoxymethoxy)methoxy)thiophene)-2,5-diyl.

The conjugated polymer can be a 3,4-disubstituted polythiophene represented by:

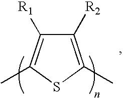

wherein independently R₁ can be an optionally substituted alkoxy group or an alkoxy heteroatom group, such as, for example, an alkoxyalkoxyalkoxy moiety, and independently R₂ can be an optionally substituted alkoxy group alkoxy heteroatom group, such as, for example, an alkoxyalkoxyalkoxy moiety; or
wherein independently R₁ can be optionally substituted alkyl, and optionally substituted aryloxy, and independently R₂ can be optionally substituted alkyl, and optionally substituted aryloxy. Examples of substituents for the optional substitution include hydroxyl, phenyl, and additional optionally substituted alkoxy groups. The alkoxy groups can be in turn optionally substituted with hydroxyl, phenyl, or alkoxy groups; or

wherein independently R₁ can be an optionally substituted alkylene oxide, and independently R₂ can be an optionally substituted alkylene oxide. Substituents can be, for example, hydroxyl, phenyl, or alkoxy groups; or

wherein independently R₁ can be optionally substituted ethylene oxide or optionally substituted propylene oxide or other lower alkyleneoxy units, and independently R₂ can be optionally substituted ethylene oxide or optionally substituted propylene oxide or other lower alkyleneoxy units. Substituents can be for example hydroxyl, phenyl, or alkoxy groups; or

wherein independently R₁ can be an optionally substituted alkylene such as, for example, methylene or ethylene, with substituents being for example optionally substituted alkyleneoxy such as ethyleneoxy or propyleneoxy; substituents can be, for example, hydroxyl, phenyl, or alkoxy, and independently R₂ can be an optionally substituted alkylene such as, for example, methylene or ethylene, with substituents being for example optionally substituted alkyleneoxy such as ethyleneoxy or propyleneoxy; substituents can be, for example, hydroxyl, phenyl, or alkoxy.

In addition, the substitutent groups R₁ and R₂ can be linked to the thiophene by an oxygen atom such as alkoxy or phenoxy, wherein the substituent can be characterized by the corresponding alcohol or phenol, respectively. The alcohol, for example, can be linear or branched, and can have C2-C20, or C4-C18, or C6 to C14 carbon atoms. The alcohol can be for example an alkyl alcohol, or an ethylene glycol, or a propylene glycol, or a diethylene glycol, or a dipropylene glycol, or a tripropylene glycol. Additional examples can be monoethylene glycol ethers and acetates, diethylene glycol ethers and acetates, triethylene glycol ethers and acetates, and the like. Examples of alcohols which can be linked to the thiophene ring through the oxygen atom include hexyl cellosolve, Dowanol PnB, ethyl carbitol, Dowanol DPnB, phenyl carbitol, butyl cellosolve, butyl carbitol, Dowanol DPM, diisobutyl carbinol, 2-ethylhexyl alcohol, methyl isobutyl carbinol, Dowanol Eph, Dowanol PnP, Dowanol PPh, propyl carbitol, hexyl carbitol, 2-ethylhexyl carbitol, Dowanol DPnP, Dowanol TPM, methyl carbitol, Dowanol TPnB. The trade names are well known in this art. Polythiophene substituents, including various alkoxy and polyether substituents, and formulations are described in, for example, U.S. patent application Ser. No. 11/826,394 filed Jul. 13, 2007 (US publication 2008/0248313).

The degree of polymerization n is not particularly limited but can be, for example, 2 to 500,000 or 5 to 100,000 or 10 to 10,000, or 10 to 1,000, 10 to 500, or 10 to 100. In many cases, and polymer has a number average molecular weight between approximately 5,000 and 100,000 g/mol. In some embodiments, R can be a monoalkoxy, dialkoxy, trialkoxy, or tetraalkoxy group and the conjugated polymer is a poly(3,4-dialkoxythiophene) or poly(3,4-dipolyetherthiophene).

In one embodiment, R₁ is a butoxyethoxy(ethoxy), R₂ is a butoxyethoxy(ethoxy), and the polymer is a poly-3,4-bis(2-(2-butoxyethoxy)ethoxy)thiophene-2,5-diyl represented by:

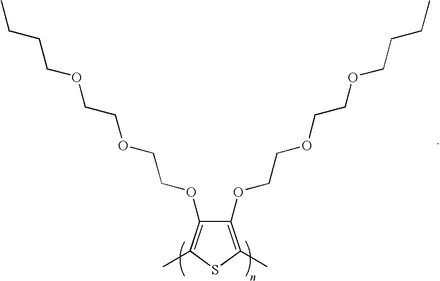

The degree of polymerization n is not particularly limited but can be, for example, 2 to 500,000 or 5 to 100,000 or 10 to 10,000, or 10 to 1,000, or 10 to 100. In many cases, and polymer has a number average molecular weight between approximately 5,000 and 100,000 g/mol.

In another embodiment, the R₁ is a methoxyethoxy(ethoxy) and R₂ is a methoxyethoxy(ethoxy), and the repeat unit is a 3,4-bis(2-(2-methoxyethoxy)ethoxy)thiophene-2,5-diyl represented by:

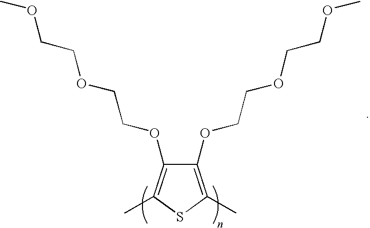

The degree of polymerization n is not particularly limited but can be, for example, 2 to 500,000 or 5 to 100,000 or 10 to 10,000, or 10 to 1,000, or 10 to 100. In many cases, and polymer has a number average molecular weight between approximately 5,000 and 100,000 g/mol.

In other embodiments the repeat unit can be, for example, 3,4-bis(2-(2-ethoxyethoxy)ethoxy)thiophene-2,5-diyl; 3,4-bis(2-(2-butoxybutoxy)butoxy)thiophene-2,5-diyl; 3,4-bis(2-(2-methoxymethoxy)methoxy)thiophene-2,5-diyl; and the like.

The choice of side chains in the 3- and 4-positions, including the terminal capping groups, can help to impart intractability of the doped conjugated polymer to certain solvents, for example toluene, tetrahydrofuran (THF), or chloroform. The intractability to solvents can enable orthogonal compatibility which is necessary for solution processed devices. This intractability can allow the conjugated polymer to be used as an HIL that is first formulated into an HIL ink to be used in the preparation of devices that are manufactured using solution processes with other ink systems used from adjacent layers. Additionally, side chain choice, including the terminal capping groups, can alter the dielectric constant between interfaces, which may affect charge transport across the interfaces.

In one embodiment, the conjugated polymer in either the neutral or oxidized state, is soluble and/or dispersible in an aromatic hydrocarbon solvent. In another embodiment, the conjugated polymer may be soluble in tetrahydrofuran (THF) and/or chloroform.

After polymerization, the conjugated polymer typically has a number average molecular weight between approximately 1,000 and 1,000,000 g/mol. More typically, the polymer has a number average molecular weight between approximately 5,000 and 100,000 g/mol.

The polymer can be a thiophene polymer or a non-thiophene polymer. The polymer can be prepared by metal promoted cross coupling reactions, as described, for example, in Elena Sheina PhD thesis, Carnegie Mellon University, 2004 (“Synthesis and Characterization of Novel Regioregular Thiophene Polymers with Polyetheric Substituents”), and references cited therein. Other carbon-carbon bond formations to form polymers are described extensively in McCullough, “The Chemistry of Conducting Polythiophenes,” Adv. Materials, 1998, 10, 2, 93-116, and references cited therein including, for example, Kumada, Yamamoto, Rieke, and Stille methods. Other examples include Pd-catalyzed Suzuki coupling, Heck coupling, as well as condensation methods like Wittig reaction, or Homer-Emmons reaction, or Knoevenagel reaction, or dehalogenation of dibenzyl halides (as described in U.S. Pat. No. 7,288,329).

The polymer can be treated so as to remove impurities such as, for example, reaction side products and metals. The removal of impurities can improve device performance such as, for example, improve efficiency, lifetime, and/or other parameters in, for example, OLED or OPV testing. Purification can be carried out in a way to remove metals even if some metals can be complexed with pendent groups such as, for example, alkyleneoxy side groups via oxygen atom binding. Groups can be specifically functionalized for binding.

In particular, polymer treatment can include at least one dehalogenation step for removal of halogens such as chlorine, bromine, and iodine.

Dehalogenation can be carried out as a result of steps taken during polymerization, or steps taken after polymerization but before polymer workup and isolation, or steps taken after a polymer has been worked up and isolated.

### Dehalogenation Step

In addition, the polymer can be treated to carry out dehalogenation and, in particular, tailor end groups by dehalogenation. End group modification is known in the art. See, for example, J. Liu et al., Macromolecules, 2002, 35, 9882-9889 including Scheme 3 where bromine end group is converted to hydrogen end group via a Grignard reagent for a polyalkylthiophene. See also, Hiorns et al., Polym. Int., 55: 608-620 (2006) for description of debrominated chain ends. Dehalogenation and reduction in halogen content are described in, for example, US Patent Publication No. 2007/0060777 (Morikawa et al.), and U.S. Pat. No. 7,368,624 (Brown et al.). End group modification, including monocapping processes and monocapped polymers, is also described in, for example, U.S. patent application Ser. No. 11/375,581 filed Mar. 15, 2006.

In one embodiment, the polymer can be treated to remove any or most halogen end groups such as, for example, bromine end groups. This can be called a dehalogenation process.

In one embodiment, the polymer can be treated for dehalogenation with a magnesium compound or reagent, such as a Grignard reagent (see also, for example, magnesium reagents, including activated magnesium reagents, described in US Patent Publication 2008/0146754 to Iovu et al., “Universal Grignard Metathesis Polymerization.” The magnesium reagent can be coupled with an activation agent such as lithium chloride. In some embodiments, use of the activation agent may reduce the amount of dehalogenation reagent needed which can reduce and/or limit potential side reactions, and the amounts of impurities that can be damaging to the polymer and cause structural defects.

One embodiment provides Ni(0) as a dehalogenation reagent. The amount of halogen before dehalogenation can be, for example, at least 1,000 ppm, or at least 2,000 ppm, or at least 3,000 ppm. The reduction can be at least a ten fold reduction.

With dehalogenation, the control of the amount of halogen can improve device performance such as, for example, improve efficiency, lifetime, or other parameters in, for example, OLED or OPV testing. For example, a parameter may be improved by at least 10 percent, or at least 25 percent, or at least 50 percent, or at least 75 percent, or at least 100 percent. Control devices can be compared to measure percent difference.

Dehalogenation can be carried out in a way to minimize introduction of defects, side reactions, or impurities into the polymer. For example, the temperature and time of reaction can be controlled. The concentration and amount of the dehalogenation agent can be controlled. Quenching conditions and chemicals such as concentrated HCl can be controlled. Purification steps can be taken after dehalogenation such as precipitation, washing, drying, and filtering. The amount of components such as metals, e.g., Mg, Ni, Li, and halogen such as Br can be measured at any point in the process.

The molar amount of the dehalogenation reagent can be controlled with respect to the amount of monomer repeat unit. For example, the molar ratio could be between 1:10 and 10:1, or between 1:5 and 5:1, or between about 1:3 and 3:1.

The weight percentage of the halogen can be measured before and after treatment, and dehalogenation can result in reduced weight percentage of halogen (or measured as ppt or ppm). For example, halogen content may be at least 1,000 ppm before dehalogenation but reduced to less than 100 ppm, or less than 10 ppm, after dehalogenation.

Methods known in the art can be used to measure halogen content. For example, ICP-MS or atomic absorption spectroscopy can be used.

In one embodiment, alkyl lithium can be excluded as a dehalogenation agent including, for example, n-butyl lithium.

In one embodiment, zinc can be excluded as a dehalogenation agent.

### Ink Compositions and Coating

Polymers can be formulated into inks with use of solvent systems comprising one or more solvents. Organic solvent or aqueous solvent can be used. Solvent mixtures can be used. Additional polymer(s) or low molecular weight components can be added. Hole transporting components can be added.

The polymers can be doped with dopants including inorganic and organic dopants, as well as redox dopants or redox active dopants.

Inks can be coated onto substrates and layers by methods known in the art. Substrates and layers used for organic electronic devices can be used.

### Amounts

In one embodiment, the composition comprises between about 1% and 99% by weight of the conjugated polymer and between about 1% and 99% by weight of the dopant such as a redox dopant. In another embodiment, the composition comprises between about 25 and 99% for the conjugated polymer and between about 1% and 75% of the dopant such as a redox dopant. Typically, the amount by weight of the conjugated polymer is greater than the amount by weight of the dopant such as a redox dopant.

The conjugated polymer can be any conjugated polymer as described above. Typically, the repeat unit is a 3,4-disubstituted polythiophene. Typically, the dopant such as a redox dopant can be an iodonium salt in an amount of about 0.01 m/ru to about 1 m/ru, wherein m is the molar amount of iodonium salt and ru is the molar amount of conjugated polymer repeat unit.

In some embodiments, where the composition comprises a solvent or a solvent carrier, the composition comprises at least 97 wt % solvent or solvent carrier, and the composition is characterized by a percent solids of 3 wt % or less.

### Devices

Various devices can be fabricated in many cases using multilayered structures which can be prepared by, for example, solution or vacuum processing, as well as printing and patterning processes. In particular, use of the embodiments described herein for hole injection layers (HILs), hole transport layer (HTL), hole collection layer, or active layer, wherein the composition is formulated for use as a hole injection layer, hole transport layer, or active layer can be carried out effectively. In particular, applications include hole injection layer for OLEDs, PLEDs, PHOLEDs, SMOLEDs, ESDs, photovoltaic cells, supercapacitors, hybrid capacitors, cation transducers, drug release, electrochromics, sensors, FETs, actuators, and membranes. Another application is as an electrode modifier including an electrode modifier for an organic field effect transistor (OFETS). Other applications include those in the field of printed electronics, printed electronics devices, and roll-to-roll production processes. Additionally, the compositions discussed herein may be a coating on an electrode.

For example, photovoltaic devices are known in the art. See for example US Patent Publication 2006/0076050 published Apr. 13, 2006; see also WO 2008/018931 published Feb. 14, 2008, including descriptions of OPV active layers. The devices can comprise, for example, multi-layer structures including for example an anode, including a transparent conductor such as indium tin oxide (ITO) on glass or PET; a hole injection layer and/or a hole transport layer; a P/N bulk heterojunction layer; a conditioning layer such as LiF; and a cathode such as for example Ca, Al, or Ba. The composition can be formulated for use as a hole transport layer. Devices can be adapted to allow for current density versus voltage measurements.

Similarly, OLED devices are known in the art. See for example US Patent Publication 2006/00787661 published Apr. 13, 2006. The devices can comprise, for example, multi-layer structures including for example an anode, including a transparent conductor such as ITO on glass or PET or PEN; a hole injection layer; an electroluminescent layer such as a polymer layer; a conditioning layer such as LiF, and a cathode such as for example Ca, Al, or Ba.

Methods known in the art can be used to fabricate devices including for example OLED and OPV devices. Methods known in the art can be used to measure brightness, efficiency, and lifetimes. OLED patents include for example U.S. Pat. Nos. 4,356,429 and 4,539,507 (Kodak). Conducting polymers which emit light are described in for example U.S. Pat. Nos. 5,247,190 and 5,401,827 (Cambridge Display Technologies). See also Kraft et al., “Electroluminescent Conjugated Polymers—Seeing Polymers in a New Light,” Angew. Chem. Int. Ed., 1998, 37, 402-428, including device architecture, physical principles, solution processing, multilayering, blends, and materials synthesis and formulation, which is hereby incorporated by reference in its entirety.

Light emitters known in the art and commercially available can be used including various conducting polymers as well as organic molecules, such as materials available from Sumation, Merck Yellow, Merck Blue, American Dye Sources (ADS), Kodak (e.g, AlQ3 and the like), and even Aldrich such as BEHP-PPV. Examples of such organic electroluminescent materials include:

(i) poly(p-phenylene vinylene) and its derivatives substituted at various positions on the phenylene moiety;

(ii) poly(p-phenylene vinylene) and its derivatives substituted at various positions on the vinylene moiety;

(iii) poly(p-phenylene vinylene) and its derivatives substituted at various positions on the phenylene moiety and also substituted at various positions on the vinylene moiety;

(iv) poly(arylene vinylene), where the arylene may be such moieties as naphthalene, anthracene, furylene, thienylene, oxadiazole, and the like;

(v) derivatives of poly(arylene vinylene), where the arylene may be as in (iv) above, and additionally have substituents at various positions on the arylene;

(vi) derivatives of poly(arylene vinylene), where the arylene may be as in (iv) above, and additionally have substituents at various positions on the vinylene;

(vii) derivatives of poly(arylene vinylene), where the arylene may be as in (iv) above, and additionally have substituents at various positions on the arylene and substituents at various positions on the vinylene;

(viii) co-polymers of arylene vinylene oligomers, such as those in (iv), (v), (vi), and

(vii) with non-conjugated oligomers; and

(ix) polyp-phenylene and its derivatives substituted at various positions on the phenylene moiety, including ladder polymer derivatives such as poly(9,9-dialkyl fluorene) and the like;

(x) poly(arylenes) where the arylene may be such moieties as naphthalene, anthracene, furylene, thienylene, oxadiazole, and the like; and their derivatives substituted at various positions on the arylene moiety;

(xi) co-polymers of oligoarylenes such as those in (x) with non-conjugated oligomers;

(xii) polyquinoline and its derivatives;

(xiii) co-polymers of polyquinoline with p-phenylene substituted on the phenylene with, for example, alkyl or alkoxy groups to provide solubility; and

(xiv) rigid rod polymers such as poly(p-phenylene-2,6-benzobisthiazole), poly(p-phenylene-2,6-benzobisoxazole), polyp-phenylene-2,6-benzimidazole), and their derivatives.

(xv) polyfluorene polymers and co-polymers with polyfluorene units

Preferred organic emissive polymers include SUMATION Light Emitting Polymers (“LEPs”) that emit green, red, blue, or white light or their families, copolymers, derivatives, or mixtures thereof; the SUMATION LEPs are available from Sumation KK. Other polymers include polyspirofluorene-like polymers available from Covion Organic Semiconductors GmbH, Frankfurt, Germany (now owned by Merck®).

Alternatively, rather than polymers, small organic molecules that emit by fluorescence or by phosphorescence can serve as the organic electroluminescent layer. Examples of small-molecule organic electroluminescent materials include: (i) tris(8-hydroxyquinolinato) aluminum (Alq); (ii) 1,3-bis(N,N-dimethylaminophenyl)-1,3,4-oxidazole (OXD-8); (iii)-oxo-bis(2-methyl-8-quinolinato)aluminum; (iv) bis(2-methyl-8-hydroxyquinolinato) aluminum; (v) bis(hydroxybenzoquinolinato) beryllium (BeQ.sub.2); (vi) bis(diphenylvinyl)biphenylene (DPVBI); and (vii) arylamine-substituted distyrylarylene (DSA amine).

Such polymer and small-molecule materials are well known in the art and are described in, for example, U.S. Pat. No. 5,047,687 issued to VanSlyke; and Bredas, J.-L., Silbey, R., eds., Conjugated Polymers, Kluwer Academic Press, Dordrecht (1991).

Examples of HIL in devices include:

1) Hole injection in OLEDs including PLEDs and SMOLEDs; for example, for HIL in PLED, all classes of conjugated polymeric emitters where the conjugation involves carbon or silicon atoms can be used. For HIL in SMOLED, the following are examples: SMOLED containing fluorescent emitters; SMOLED containing phosphorescent emitters; SMOLEDs comprising one or more organic layers in addition to the HIL layer; and SMOLEDs where the small molecule layer is processed from solution or aerosol spray or any other processing methodology. In addition, other examples include HIL in dendrimer or oligomeric organic semiconductor based OLEDs; HIL in ambipolar light emitting FET's where the HIL is used to modify charge injection or as an electrode;

2) Hole extraction layer in OPV:

3) Channel material in transistors

4) Channel material in circuits comprising a combination of transistors such as logic gates

5) Electrode material in transistors

6) Gate layer in a capacitor

7) Chemical sensor where modification of doping level is achieved due to association of the species to be sensed with the conductive polymer.

A variety of photoactive layers can be used in OPV devices. Photovoltaic devices can be prepared with photoactive layers comprising fullerene derivatives mixed with for example conducting polymers as described in for example U.S. Pat. Nos. 5,454,880 (Univ. Cal.); 6,812,399; and 6,933,436. Also, photoactive layers may comprise blends of conducting polymers, blends of conducting polymers and semiconducting nanoparticles, and bilayers of small molecules such as pthalocyanines, fullerenes, and porphyrins.

Common electrode materials and substrates, as well as encapsulating materials can be used.

A method of making a device typically comprises the steps of providing a substrate; layering a transparent conductor on the substrate; providing an HIL or HTL ink composition comprising a conjugated polymer doped with a photoacid in a solvent as described herein; layering the composition on the transparent conductor to form a hole injection layer or hole transport layer; layering an active layer on the hole injection layer or hole transport layer; and layering a cathode on the active layer.

In another embodiment, a method of making a device comprises applying an HIL or HTL ink composition comprising a conjugated polymer doped with a photoacid in a solvent as described herein as part of an HIL or HTL layer in an OLED, a photovoltaic device, an ESD, a SMOLED, a PLED, a sensor, a supercapacitor, a cation transducer, a drug release device, an electrochromic device, a transistor, a field effect transistor, an electrode modifier, an electrode modifier for an organic field transistor, an actuator, or a transparent electrode.

### OLED Measurements

Methods known in the art can be used to measure OLED parameters. For example, measurements can be carried out at 10 mA/cm².

Voltage can be for example from about 2 to about 15, or about 2 to about 8, or about 2 to 5, or from about 3 to about 14, or from about 3 to about 7.

Brightness can be, for example, at least 250 cd/m², or at least 500 cd/m², or at least 750 cd/m², or at least 1,000 cd/m².

Efficiency can be, for example, at least 0.25 Cd/A, or at least 0.45 Cd/A, or at least 0.60 Cd/A, or at least 0.70 Cd/A, or at least 1.00 Cd/A, or at least 2.5 Cd/A, or at least 5.00 Cd/A, or at least 7.50 Cd/A, or at least 10.00 Cd/A, or at least 20 Cd/A, or at least 30 Cd/A, or at least 60 Cd/A, or at least 80 Cd/A. An upper limit can be for example about 200 Cd/A.

Lifetime can be measured at 50 mA/cm² or up to 75 mA/cm² in hours and can be, for example, at least 50 hours, or at least 100 hours, or at least about 900 hours, or at least 1,000 hours, or at least 1100 hours, or at least 2,000 hours, or at least 5,000 hours, or at least 10,000 h, or at least 20,000 h, or at least 50,000 h. Methods known in the art such as, for example, T50 can be used to measure lifetime.

Combinations of brightness, efficiency, and lifetime can be achieved. For example, brightness can be at least 1,000 cd/m², efficiency can be at least 1.00 cd/A, and lifetime can be at least 1,000 hours, at least 2,500 hours, or at least 5,000 hours.

### Embodiment A

### Use of Lithium Chloride

According to Krasovskiy A. et al. (Krasovskiy, A.; Knochel, P. Angew. Chem. Int. Ed. 2004, 43, 3333), addition of LiCl during the synthesis of functionalized aryl- and heteroarylmagnesium compounds from organic bromides can dramatically increase the rate of Br/Mg exchange and result in high conversion yields (e.g., >80%). The new reagent i-PrMgCl.LiCl, which can be made by addition of a solution of i-PrMgCl in THF to anhydrous LiCl, can apparently participate in the formation of a reactive complex 2 and prevents formation of polymeric aggregates 1 of i-PrMgCl (Scheme 1). Possibly, the magnesiate character of 2 [i-PrMgCl₂⁻Li⁺] might be responsible for the enhanced reactivity of this reagent.

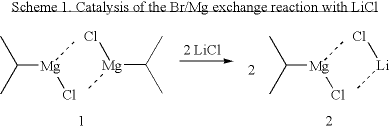

In one embodiment, LiCl can be used in the form of the i-PrMgCl.LiCl complex to improve Br/Mg exchange reaction during bromine reduction of substituted polythiophenes as illustrated in Scheme 2. The complex can be used during, immediately after the polymerization, or after isolating polymer from the reaction mixture via crashing or precipitation and redissolving it for post-polymerization treatment. The R group can be a group which imparts solubility to the polythiophene such as, for example, alkyl or alkoxy, as described above.

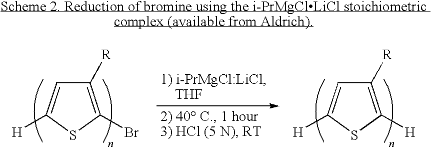

Preparation of the i-PrMgCl.LiCl reagent [Note: using higher concentrations of i-PrMgCl.LiCl is preferable for higher conversions (e.g., 2 M)]. Charge a nitrogen-purged three neck round bottom flask with i-PrMgCl (¼ the amount of Grignard used in metathesis). Add anhydrous LiCl (one to one equivalent to the Grignard used). Stir the reaction mixture at room temperature until all of LiCl dissolves (might take a few hours to dissolve; higher dilutions may take longer times). Depending on the efficiency of the reaction, the amount of the Grignard used might be reduced to 2 equivalents i-PrMgCl per polymer chain.

Further description is provided by the following working example(s).

### WORKING EXAMPLES

### Dehalogenation of a Polythiophene

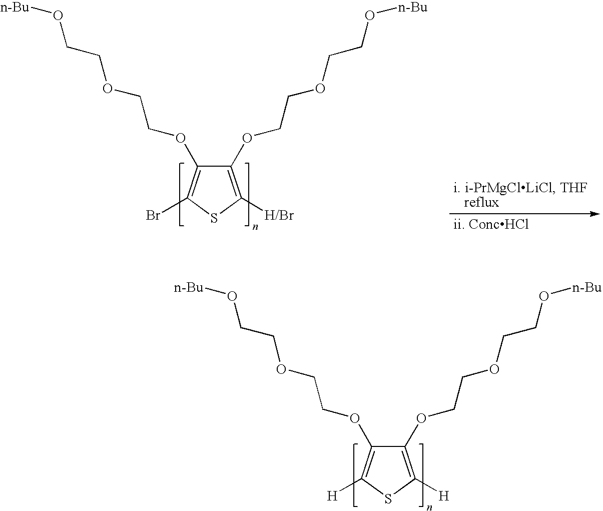

To a flame dried 1 L 3NRBF purged with nitrogen added 23.5 gms of PDBEETh followed by 500 mL of anhydrous tetrahydrofuran via cannular needle. The solution was refluxed to dissolve the polymer. Heating was stopped and 45 mL of iso-propyl magnesium chloride lithium chloride complex solution (1.3 M in THF) (1.0 eq per repeat unit of monomer) were added at room temperature, after refluxing stopped. After adding the Grignard into the reaction mixture, refluxing was resumed for additional 24 hrs. The reaction mixture was cooled to room temperature and 10 mL concentrated HCl were slowly added to the reaction mixture. After quenching the reaction. 19.5 g of dimethyl glyoxime were added to the reaction mixture and stirring continued for 30 min. The polymer was then precipitated into 5 L of methanol and filtered over a PVDF membrane filter. The wet polymer cake was subjected to another wash in 1 L methanol under continuous stirring, filtered and washed till filtrate was colorless (about 1 L of methanol was used each time). The polymer was further worked up by sequential stirring in the following solvent mixtures, filtered and washed with 500 mL of methanol-water mixture (1:1 v/v) after each filtration step. Work-up order, solvent ratios, time and temperature are as indicated below.
1. 1 L methanol-water mixture (1:1 v/v) with heating at 50° C. for 1 h.
2. 500 mL methanol-water (1:1 v/v) with conc. HCl with heating at 50° C. for 1 h.
3. 2×500 mL methanol-water (1:1 v/v) with heating at 50° C. for 1 h.
   After the last wash step, the polymer was filtered, dried over the funnel for 30-40 min and then dried in vacuum oven for three days at 70° C. yielding 20 g of polymer.

TABLE 1
Mg, Ni, Li and Br analysis of PDBEETh by ICP-MS
before and after de-halogenation step.

| Description | Mg, pp | Ni, ppm | Li, ppm | Br, ppm |
|---|---|---|---|---|
| Before de- | 24 | 0.982 | — | 1910 |
| halogenation | | | | |
| After de- | <6.12 * | 3.66 | 7.34 | <83.5 |
| halogenation | | | | |

* < below detection limits of the lab (R. J. Lee Group, Inc. laboratory report).

### Additional Embodiment

### De-halogenation of Poly((3-methoxyethoxyethoxy)thiophene)

To a dry 1 L three necked round bottom flask added 15.01 g of poly((3-methoxyethoxyethoxy)thiophene) and 500 mL of anhydrous anisole was cannulated. The reaction mixture was heated to 80° C. for 1 hr to dissolve the polymer. To this solution 58 mL of i-propylmagnesium chloride lithium chloride complex (1.3 M in THF) was added slowly at 70° C. The reaction mixture was heated to 73° C. for an additional 24 hrs and quenched with a few drops of concentrated hydrochloric acid. Then 17.42 g of dimethyl glyoxime and 50 mL THF was added to the reaction mixture. The polymer was then precipitated into 6 L of hexanes, filtered and washed with 200 mL hexanes. The filtered solids were further stirred in 600 mL hexanes for 30 min, filtered and washed with hexane till colorless. The filtered polymer was suction dried on the funnel and then air-dried for 48 hrs.

The dry polymer was stirred in 300 mL methanol for 30 min at about 50° C. and then 150 mL de-ionized water was added. Stirring and heating of the polymer was continued for an additional 30 min and then filtered. The polymer was washed with 300 mL of a 1:1 (v/v) methanol-water mixture. This process was repeated one more time.

The filtered polymer was stirred again in 150 mL methanol with heating (55° C.) for 30 min. 450 mL of de-ionized water was added and the heat treatment continued for another 45 min before filtering off the polymer. The polymer was subsequently washed with 300 mL of a 1:1 (v/v) methanol-water mixture. The polymer was suction dried on the funnel for about 30 min and then in a vacuum oven at 65° C. till a constant weight of 12.8 g.

The bromine content was reduced from an initial value of 23,400 ppm to 671 ppm by the above treatment.

1. A composition comprising:
at least one polythiophene, wherein the polythiophene has been prepared by steps which comprise a dehalogenation step.

2. The composition according to claim 1, wherein the dehalogenation step comprises reducing a weight percentage of bromine.

3. A composition according to claim 1, wherein the polythiophene has a halogen content of less than 100 ppm after dehalogenation.

4. A composition according to claim 1, wherein the polythiophene has a bromine content of less than 100 ppm after dehalogenation.

5. A composition according to claim 1, wherein the polythiophene has a halogen content of less than 10 ppm after dehalogenation.

6. A composition according to claim 1, wherein the polythiophene has a bromine content of less than 10 ppm after dehalogenation.

7. A composition according to claim 1, wherein the polythiophene is a regioregular polythiophene.

8. A composition according to claim 1, wherein the polythiophene is a 3,4-substituted dialkoxypolythiophene.

9. A composition according to claim 1, wherein the polythiophene is a soluble polythiophene.

10. A composition according to claim 1, wherein the dehalogenation is carried out with use of a magnesium reagent.

11. A composition according to claim 1, wherein the dehalogenation is carried out with use of a magnesium reagent coupled with an activation agent.

12. A composition according to claim 1, wherein the dehalogenation is carried out with use of a Grignard reagent coupled with an activation agent.

13. A composition according to claim 1, wherein the dehalogenation is carried out with use of a Grignard reagent coupled with a lithium activation agent.

14. A composition according to claim 1, wherein the dehalogenation step is carried out as part of polymerization of the polythiophene.

15. A composition according to claim 1, wherein the dehalogenation step is carried out after polymerization of the polythiophene is substantially complete but before workup of the polythiophene.

16. A composition according to claim 1, wherein the dehalogenation step is carried out after polymerization of the polythiophene is substantially complete and after the polythiophene has been purified and redissolved.

17. A composition according to claim 1, wherein dehalogenation is carried out to reduce halogen levels such that a parameter in an organic electronic device is improved by at least 10% as a result of dehalogenation and use of the dehalogenated polymer in the device.

18. A composition according to claim 1, wherein dehalogenation is carried out to reduce halogen levels such that a parameter in an organic electronic device is improved by at least 25% as a result of dehalogenation and use of the dehalogenated polymer in the device.

19. A composition according to claim 1, wherein dehalogenation is carried out to reduce halogen levels such that a parameter in an organic electronic device is improved by at least 50% as a result of dehalogenation and use of the dehalogenated polymer in the device.

20. A composition according to claim 1, wherein dehalogenation is carried out to reduce halogen levels such that a parameter in an organic electronic device is improved by at least 75% as a result of dehalogenation and use of the dehalogenated polymer in the device.

21. A composition comprising:
at least one polythiophene, wherein the polythiophene has been prepared by steps which comprise a dehalogenation step, and at least one solvent for the polymer.

22. The composition of claim 21, wherein the solvent is an organic solvent.

23. The composition of claim 21, wherein the solvent is water.

24. The composition of claim 21, wherein the solvent is a non-halogenated solvent.

25. The composition of claim 21, wherein the solvent is a halogenated solvent.

26. (canceled)

27. The composition of claim 21, wherein the polythiophene has a halogen content before dehalogenation of at least 1,000 ppm, and a halogen content after dehalogenation of less than 100 ppm (by weight).

28. (canceled)

29. (canceled)

30. The composition of claim 21, wherein the polythiophene is stable in the solvent from precipitation or gellation for at least seven days at 25° C.

31. A method comprising:
dehalogenating at least one polythiophene.

32. The method of claim 31, wherein the dehalogenating is carried out as the polythiophene is being prepared by polymerization.

33. The method of claim 31, wherein the dehalogenating is carried out after the polythiophene has been prepared by polymerization.

34. The method of claim 31, wherein the dehalogenating is carried out after the polythiophene has been prepared by polymerization and after the polythiophene has been purified and redissolved.

35. The method of claim 31, wherein dehalogenating is carried out is carried out with use of a magnesium reagent.

36. The method of claim 31, wherein dehalogenating is carried out is carried out with use of a magnesium reagent coupled with an activation agent.

37. The method of claim 31, wherein the dehalogenation is a debromination.

38. (canceled)

39. The method of claim 31, wherein the dehalogenation results in a halogen content of less than 100 ppm.

40. The method of claim 31, wherein the dehalogenation results in a bromine content of less than 100 ppm.

41. A device comprising:
a substrate,
a plurality of layers disposed on the substrate,
wherein at least one of the layers comprise at least one polythiophene which has been prepared by a dehalogenation step.

42. The device of claim 41, wherein the substrate and layers form an organoelectronic device.

43-48. (canceled)

49. The device according to claim 41, wherein the dehalogenation improves at least one device performance parameter by at least 10%.

50. The device according to claim 41, wherein the dehalogenation improves at least one device performance parameter by at least 10%, and the device performance parameter is a lifetime.

51-59. (canceled)
